(19) United States
(12) Patent Application Publication
(10) Pub. No.: US 2026/0255330 A1
(43) Pub. Date: Aug. 27, 2026

(54) RANDOM ACCESS METHOD, APPARATUS AND COMMUNICATION SYSTEM

(71) Applicant: CHINA SATELLITE NETWORK INNOVATION CO.,LTD, Beijing (CN)

(72) Inventors: Ying ZHAO, Beijing (CN); Junshuai SUN, Beijing (CN); Yingying WANG, Beijing (CN)

(21) Appl. No.: 19/540,334

(22) Filed: Feb. 13, 2026

Related U.S. Application Data
(63) Continuation-in-part of application No. PCT/CN2025/123367, filed on Sep. 23, 2025.

(30) Foreign Application Priority Data
Feb. 25, 2025 (CN) 202510214115.9

(51) Int. Cl. H04W 72/0446; H04L 5/00; H04W 72/0453; H04W 72/23; H04W 74/00; H04W 74/0833

(52) U.S. Cl. CPC H04W 72/0446; H04L 5/0053; H04W 72/0453; H04W 72/23; H04W 74/006; H04W 74/0833

(57) ABSTRACT

The present disclosure provides a random access method, an apparatus and a communication system. The terminal device side adds, according to compensation frequencies corresponding to respective ROs in respective RO groups, the compensation frequencies to frequency-domain resources used for transmitting PRACH signals; and transmits the PRACH signals that have been frequency-compensated using the RO group. The network device side receives a plurality of PRACH signals transmitted by the terminal device; determines, according to the plurality of PRACH signals, an optimal dynamic compensation frequency; and transmits a random access response message indicating the optimal dynamic compensation frequency.

### CROSS-REFERENCE TO RELATED APPLICATIONS

The present application is a continuation in part under 35 U.S.C. § 111(a) of International Patent Application No. PCT/CN 2025/123367, filed on Sep. 23, 2025, which claims priority to Chinese Patent No. 202510214115.9, entitled “Random Access Method, Apparatus and Communication System”, and filed on Feb. 25, 2025, both of which are incorporated herein by reference in their entireties.

### TECHNICAL FIELD

The present application relates to the field of communications, in particular to a random access method, apparatus and a communication system.

### BACKGROUND

Compared with Terrestrial Networks (TNs), Non-Terrestrial Networks (NTNs) experience larger propagation delays and Doppler frequency shifts. The time and frequency drifts caused by rapid movement of medium and low orbit satellites pose significant challenges to synchronization schemes designed based on terminal mobility in TNs. Meanwhile, due to the constraints such as the limited satellite payload power, large satellite coverage areas, and limited feeder link bandwidth, the NTNs may suffer from poor downlink coverage performance.

A User Equipment (UE) achieves uplink time synchronization and uplink frequency synchronization by transmitting a Physical Random Access Channel (PRACH) signal and receiving feedback from a base station in the access process. Due to the limited transmission power of the terminal device and the significantly longer communication distances in NTNs as compared to the conventional TNs, continuing to use the PRACH schemes designed for TNs, especially for the reduced capability (e)RedCap type terminal devices and the IoT physical network type terminal device whose capability is further weakened when accessing the NTN, may result in the random access message transmitted by the UE failing to be properly received and decoded by the base station, directly affecting uplink synchronization performance.

### SUMMARY

For uplink frequency synchronization, according to the existing 3GPP NR NTN protocol, the terminal device may acquire its position information through its own Global Navigation Satellite System (GNSS) module, and obtain ephemeris information from the system information broadcast by the base station, thereby comprehensively calculating a Doppler frequency shift of a service link and performing frequency-domain pre-compensation on the PRACH it transmits. However, due to the various disturbances to satellite movement, the limited positioning accuracy of the terminal device, and the inability of the network device to provide direct frequency compensation information to the terminal device during the initial access stage, the calculation accuracy and timeliness of an open-loop frequency pre-compensation algorithm that relies on the (semi-)static ephemeris information will also be affected.

The present application aims at solving the problem in existing communication systems, particularly in NTN systems, where during terminal device access, a network device is unable to provide direct frequency compensation information to the terminal device, and the accuracy of frequency pre-compensation is low due to various perturbations affecting the network device.

To solve the technical problem, the present disclosure provides a random access apparatus, applied to a terminal device, comprising:
a processing unit configured to add, according to compensation frequencies corresponding to respective ROs in an RO group, the compensation frequencies to frequency-domain resources used for transmitting PRACH signals; and
a transmitting unit configured to transmit, using the RO group, the PRACH signals that have been frequency-compensated.

The present disclosure also provides a random access apparatus, applied to a network device, comprising:
a receiving unit configured to receive a plurality of PRACH signals transmitted by a terminal device, wherein frequency-domain resources used for transmitting the PRACH signals are added with compensation frequencies;
a processing unit configured to determine, according to the plurality of PRACH signals, an optimal dynamic compensation frequency; and
a first transmitting unit configured to transmit a random access response message indicating the optimal dynamic compensation frequency.

The present disclosure further provides a random access method, applied to a terminal device, comprising:
adding, according to compensation frequencies corresponding to respective ROs in an RO group, the compensation frequencies to frequency-domain resources used for transmitting PRACH signals; and
transmitting, using the RO group, the PRACH signals that have been frequency-compensated.

The present disclosure further provides a random access method, applied to a network device, comprising:
receiving a plurality of PRACH signals transmitted by a terminal device, wherein frequency-domain resources used for transmitting the PRACH signals are added with compensation frequencies;
determining, according to the plurality of PRACH signals, an optimal dynamic compensation frequency; and
transmitting a random access response message indicating the optimal dynamic compensation frequency.

The present disclosure further provides a communication system, comprising: a terminal device and a network device.

The terminal device is configured to execute a random access method applied to a terminal device side.

The network device is configured to execute a random access method applied to a network device side.

In the random access method, apparatus and communication system provided in the present disclosure, by combining a random access occasion group (RO group) with PRACH transmission frequency compensation, a terminal device is allowed to carry real-time and high-precision frequency compensation in random access information when transmitting the random access information, so that a network device (base station) can receive the access information using a matching frequency, thereby achieving better reception performance.

To make the above-mentioned and other purposes, features and advantages of the present application more obvious and understandable, detailed descriptions of the preferred embodiments are provided below with reference to the drawings.

### BRIEF DESCRIPTION OF THE DRAWINGS

In order to more clearly illustrate the technical solutions in the embodiments of the present disclosure or in the prior art, the drawings required for describing the embodiments or the prior art are briefly introduced below. Apparently, the drawings described below just illustrate some embodiments of the present disclosure, and a person of ordinary skill in the art can obtain other drawings from these drawings without paying creative effort.

FIG. 1 is a structural diagram of a communication system according to an embodiment of the present disclosure;

FIG. 2 is a flowchart of a random access method applied to a terminal device side according to an embodiment of the present disclosure;

FIG. 3 is another flowchart of a random access method applied to a terminal device side according to an embodiment of the present disclosure;

FIG. 4 is a further flowchart of a random access method applied to a terminal device side according to an embodiment of the present disclosure;

FIG. 5 is a flowchart of a random access method applied to a network device side according to an embodiment of the present disclosure;

FIG. 6 is another flowchart of a random access method applied to a network device side according to an embodiment of the present disclosure;

FIG. 7 is a structural diagram of a random access apparatus applied to a terminal device side according to an embodiment of the present disclosure;

FIG. 8 is another structural diagram of a random access apparatus applied to a terminal device side according to an embodiment of the present disclosure;

FIG. 9 is a further structural diagram of a random access apparatus applied to a terminal device side according to an embodiment of the present disclosure;

FIG. 10 is a structural diagram of a random access apparatus applied to a network device according to an embodiment of the present disclosure;

FIG. 11 is another structural diagram of a random access apparatus applied to a network device according to an embodiment of the present disclosure;

FIG. 12 is a structural diagram of a terminal device according to an embodiment of the present disclosure;

FIG. 13 is a schematic diagram of the composition of a network device according to an embodiment of the present disclosure;

FIG. 14 is a schematic diagram of a random access procedure according to an embodiment of the present disclosure; and

FIG. 15 is a schematic diagram of an association period of SSB-to-RO mapping according to an embodiment of the present disclosure.

### DESCRIPTION OF EMBODIMENTS

The technical solutions in the embodiments of the present disclosure will be described clearly and completely in conjunction with the accompanying drawings in the embodiments of the present disclosure. Apparently, the embodiments described herein are only part of, rather than all of, the embodiments of the present disclosure. Based on the embodiments of the present disclosure, all other embodiments obtained by a person of ordinary skill in the art without paying creative effort shall fall within the scope of protection of the present application.

It should be noted that the terms “first”, “second”, and the like in the Description, the claims and the drawings of the present application are intended to distinguish similar objects, rather than to describe a particular sequence or order. It should be appreciated that the data used in this way may be interchanged where appropriate, so that the embodiments of the present disclosure described herein can be implemented in a sequence other than those illustrated or described herein. Furthermore, the terms “comprise” and “have”, as well as any variations thereof, are intended to cover a non-exclusive inclusion. For example, the processes, methods, apparatuses, products or devices that comprise a series of steps or units do not have to be limited to those steps of units clearly listed, but may also comprise other steps or units that are not clearly listed or are inherent to these processes, methods, products or equipment.

In the descriptions of the present disclosure, unless otherwise specified, “and/or” describes an association relationship between associated objects, indicating that three relationships may exist. For example, A and/or B may indicate: A exists alone, both A and B exist, or B exists alone, wherein A and B may be singular or plural. Furthermore, in the descriptions of the present disclosure, unless otherwise specified, “a plurality of” refers to two or more. “At least one of the following” or any similar expressions refer to any combination of the items, including a single item or any combination of a plurality of items. For example, at least one of a, b, or c may indicate: a, b, c, a and b, a and c, b and c, or a and b and c, wherein a, b, and c may be singular or plural.

In the present disclosure, for the purpose of determining whether a specific condition is satisfied, expressions “greater than” or “less than” may be used. However, they are merely for the expression of an example and are not intended to exclude descriptions using “above” or “below”. A condition recorded as “above” may be replaced with “greater than,” a condition recorded as “below” may be replaced with “less than,” and a condition recorded as “above and less than” may be replaced with “greater than and below”. Furthermore, hereinafter, “A to B” means at least one element from A (including A) to B (including B).

In the embodiments of the present disclosure, the singular forms “a”, “this”, and the like include the plural forms, and should be understood in a broad sense as “a kind” or “a category” rather than being limited to the meaning of “one”. In addition, the term “the” should be understood as including both the singular and the plural forms, unless otherwise explicitly specified in the context. In addition, the term “according to” should be understood as “at least partially according to . . . ”, and the term “based on” should be understood as “at least partially based on . . . ”, unless otherwise explicitly specified in the context.

The present disclosure provides the method operation steps as described in the embodiments or shown in the flowcharts, but more or fewer operation steps may be included based on conventional or non-creative efforts. The sequence of steps listed in the embodiments is merely one of a plurality of step execution sequences and does not represent a unique execution sequence. When the steps are executed by a system or an apparatus product in practice, they may be executed sequentially or in parallel in accordance with the method described in the embodiments or shown in the drawings.

It should be noted that in the embodiments of the present disclosure, some existing schemes in the industry, such as software, components, models, and the like may be mentioned. They should be regarded as exemplary, and their purpose is merely to illustrate the feasibility of the technical solutions of the present application in implementation, but does not imply that the applicant has used or will inevitably use those schemes.

Terms employed in some communication criteria (e.g., 3rd Generation Partnership Project (3GPP), European Telecommunications Standards Institute (ETSI), Extensible Radio Access Network (ERAN), and Open Radio Access Network (O-RAN)) are used in the present disclosure to describe the various embodiments, but they are just examples for illustration. The various embodiments of the present disclosure may also be readily transformed and applied in other communication systems.

In the embodiments of the present disclosure, the communications between devices in a communication system may be carried out according to a communication protocol at any stage, which for example may include, but is not limited to: 1G (generation), 2G, 2.5G, 2.75G, 3G, 4G, 4.5G, 5G, New Radio (NR), etc., and/or other communication protocols that are currently known or will be developed in the future.

For the convenience of understanding, the technical terms involved in the embodiments of the present disclosure are explained below:
(1) Terminal Device: referring to a device that has a wireless transmission and reception function and is capable of cooperating with a network side device to provide communication services for a user. The terminal device may also be referred to as a Terminal, User Equipment (UE), a User Terminal, a Mobile Terminal (MT), or a User Agent, etc. For example, the terminal device may be a Mobile Phone, a tablet computer, a laptop, a wearable device, a Virtual Reality (VR) device, an Augmented Reality (AR) device, a wireless communication device, a wireless terminal in Industrial Control, a wireless terminal in Self-Driving, a wireless terminal in Remote Medical Surgery, a wireless terminal in a Smart Grid, a wireless terminal in Transportation Safety, a wireless terminal in a Smart City, a wireless terminal in a Smart Home, an Internet of Things (IoT) device, a Narrowband Internet of Things (NB-IoT) device, a Vehicle-to-Everything (V2X) device, a device in Device-to-Device (D2D) communication, an Enhanced Machine Type Communication (eMTC) device, a Reduced Capability (RedCap) device, a cellular phone, a cordless phone, a Session Initiation Protocol (SIP) phone, a Wireless Local Loop (WLL) station, a Personal Digital Assistant (PDA), a client, a handheld device with wireless communication function, a vehicle-mounted device, or a ship-borne device, etc.

In scenarios such as the Internet of Things, the terminal device may also be a machine or apparatus for monitoring or measurement. For example, it may include, but is not limited to: a Machine Type Communication (MTC) terminal, a vehicle-mounted communication terminal, a device-to-device terminal, a Machine-to-Machine (M2M) terminal, etc.
(2) Network device: referring to a device capable of communicating with a terminal device. The network device may be located on a satellite or on the ground. The network device may also be referred to as a space base station, a satellite-borne base station, a satellite, a satellite communication node, a satellite network terminal device, a satellite communication module, or a base station, etc. The network side device may also be referred to as an access network device or a radio access network device. The network side device may be a base station (Base Transceiver Station, BTS) in a Global System for Mobile Communication (GSM) or a Code Division Multiple Access (CDMA) communication system carried by a satellite, and may also be a base station (NodeB, NB) in a Wideband Code Division Multiple Access (WCDMA) system carried by a satellite, and may also be an evolved base station (evolved NodeB, eNB or eNodeB) in an LTE system carried by a satellite, and may also be a base station in a terrestrial network or a Non-Terrestrial Network (NTN), such as a base station (gNB) in a 5G network carried by a satellite, and may also be a base station in a future network (e.g., 6G network) after 5G carried by a satellite, and may also be a base station in a future evolved Public Land Mobile Network (PLMN) carried by a satellite, and may also be a Transmission Reception Point (TRP) carried by a satellite, and may also be a wireless controller in a scenario of a Cloud Radio Access Network (CRAN) carried by a satellite, and may also be an urban base station, a micro base station, a pico base station, or a femto base station carried by a satellite. The base station may also be a ground base station capable of communicating with a satellite, and may also be referred to as an Access Point (AP), a 5G node (5th generation node), a wireless point, a Transmission/Reception Point (TRP), or other terms with equivalent technical meanings thereto. The network device may also be a base station device carried by a High Altitude Platform Station (HAPS) with a hovering capability, such as a large balloon or an airship, a base station device in a Roadside Unit (RSU), or a base station device in Vehicle-to-Everything, etc.

Both the terminal device and the base station device can perform beamforming, but the embodiments of the present disclosure are not limited thereto. In some embodiments, the terminal may or may not perform beamforming. Also, the base station may or may not perform beamforming. That is, only one of the terminal and the base station may perform beamforming, or neither may perform beamforming. In the present disclosure, a beam refers to the spatial propagation of signals in a wireless channel, which is formed by one or more antennas or antenna units, and such a formation process may be referred to as beamforming.

In addition, the term “network side” or “network device side” refers to the network side, which may be a base station, and may also include one or more network devices as mentioned above. The term “terminal side” or “terminal device side” refers to the user or terminal side, which may be a specific UE, and may also include one or more terminal devices as mentioned above.

Typically, before performing data transmission, a terminal device needs to connect to a network device through an initial access procedure. The initial access procedure includes stages such as cell search, system information reception, and random access. Cell search is a process in which a UE achieves downlink time and frequency synchronization using a cell synchronization signal and obtains a Physical Cell Identity (PCID). Thereafter, the UE acquires the system information necessary for performing random access by receiving a physical broadcast channel and a Physical Downlink Shared Channel (PDSCH) carrying remaining minimum system information. Finally, the UE achieves uplink time synchronization and obtains a Cell Radio Network Temporary Identifier (C-RNTI) information through the random access process.

Before performing the random access procedure, the UE acquires, from a system message a Synchronization Signal/PBCH Block (SSB) index set, a Physical Random Access Channel (PRACH) time-frequency resource, a PRACH preamble format, and a PRACH preamble sequence set parameter. The PRACH resource is a periodic resource. In the time-domain, different PRACH preamble formats have different durations. The configuration method for PRACH time-domain resources is the same as in Long Term Evolution (LTE), i.e., the PRACH configuration is determined by looking up a pre-defined configuration table in the protocol. There are 256 configurable indices in total, which are indicated by 8-bit signaling in SIB1. For each configuration index, the table defines a PRACH configuration period, a system radio frame index, a subframe/slot index, a starting PRACH OFDM symbol index and the number of time-domain ROs within one slot. The optional values for the PRACH configuration period are {10, 20, 40, 80, 160} ms. Within each PRACH configuration period, the PRACH resource exists only in one valid radio frame (10 ms), which contains one or more subframes/slots. In each subframe/slot, there is only one starting PRACH OFDM symbol index, and there are one or more time-domain ROs within a slot. In the frequency-domain, different PRACH preamble formats and subcarrier spacings jointly determine the frequency-domain bandwidth occupied by the PRACH. The number of different PRACH frequency-domain resources that employ Frequency Division Multiplexing (FDM) on the same time-domain resource can be 1, 2, 4, or 8, and the specific value is indicated by 2-bit signaling in SIB1.

The 3GPP NR standard specification defines three PRACH configuration tables. The PRACH configuration index indicates the PRACH preamble format, period, system frame number, subframe/slot number, starting symbol index within a slot, and the number of time-domain ROs within a slot. When the PRACH preamble subcarrier spacing is 15 kHz, the number of PRACH slots in one subframe is 1; when the subcarrier spacing is 30 kHz, the number of PRACH slots in one subframe is 1 or 2. If the number is 1, the second PRACH slot is used. If multiple ROs are configured in one slot, the ROs are numbered in time-domain order.

The UE generates a PRACH preamble sequence according to the PRACH preamble format and the PRACH preamble sequence set parameter, and randomly selects a PRACH time-frequency resource from a candidate set of PRACH time-frequency resources for transmitting random access information (e.g., Message 1, Msg1, Message A, MsgA, which contains at least the PRACH preamble sequence). The base station performs detection on the preamble sequence. If the base station detects the preamble sequence, it feeds back corresponding Random Access Response (RAR) information on the PDCCH/PDSCH.

A Random Access Channel Occasion (RO) refers to a time-frequency resource used for transmitting an initial access message (e.g., Message 1, MsgA) based on a PRACH preamble via a specific transmit beam. To improve the uplink coverage of random access, for PRACH transmission with preamble repetition, one PRACH occasion (RO) refers to the time-frequency resource used for one preamble transmission.

For NR coverage enhancement, the 3GPP standard specification introduces a PRACH enhancement method. Through the Random Access Occasion group (RO group) method specified in the 3GPP standard specification, where each RO group contains multiple ROs consecutive in the time-domain, the UE's access capability and uplink synchronization performance can be significantly improved based on the terminal's repeated PRACH transmissions and the base station's joint reception.

Furthermore, for uplink frequency synchronization, according to the existing 3GPP NR NTN protocol, a terminal may obtain its position information via its own Global Navigation Satellite System (GNSS) module and acquire ephemeris information from system information broadcast by a base station, thereby comprehensively calculating the Doppler frequency shift of a service link and performing frequency-domain pre-compensation on the transmitted PRACH. However, due to various perturbations in satellite movement and the limited positioning accuracy of the terminal device, and the network device's inability to provide direct frequency compensation information to the terminal device during the access stage, the calculation accuracy and timeliness of the open-loop frequency pre-compensation algorithm relying on (semi-)static ephemeris information are also affected.

Aiming at the above technical problem existing in the prior art, the present application proposes a solution that combines an RO group with PRACH transmit frequency compensation. This enables a terminal device to carry real-time and high-precision frequency compensation when transmitting random access information, so that a network device (e.g., a base station) can receive the access information using a matching frequency, thereby obtaining better reception performance.

### Embodiments of a First Aspect

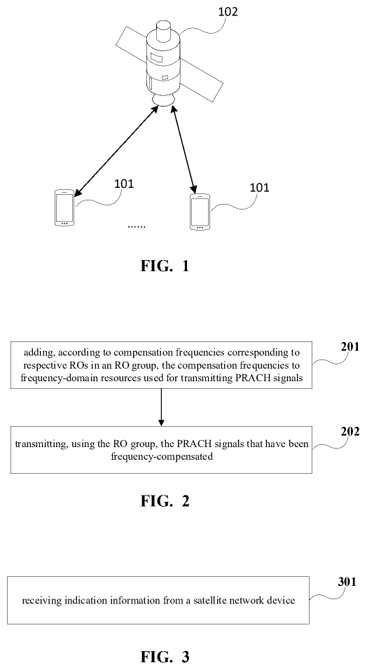

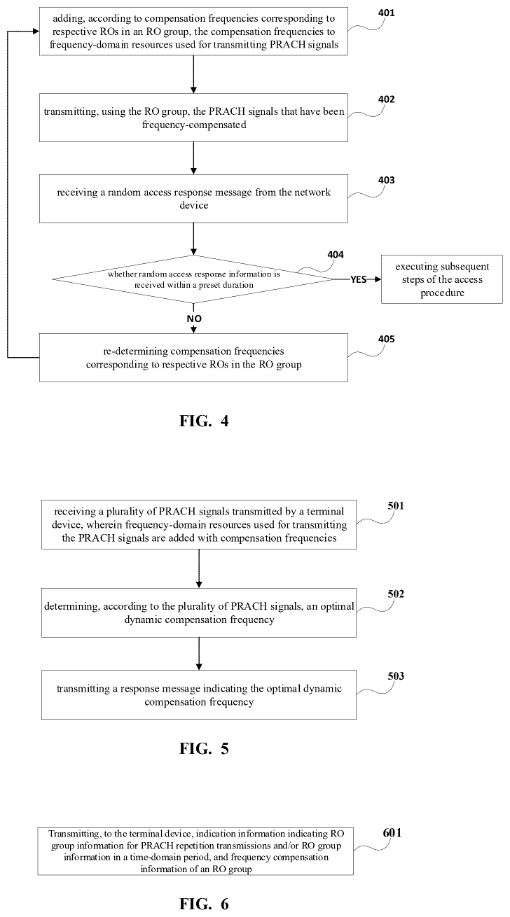

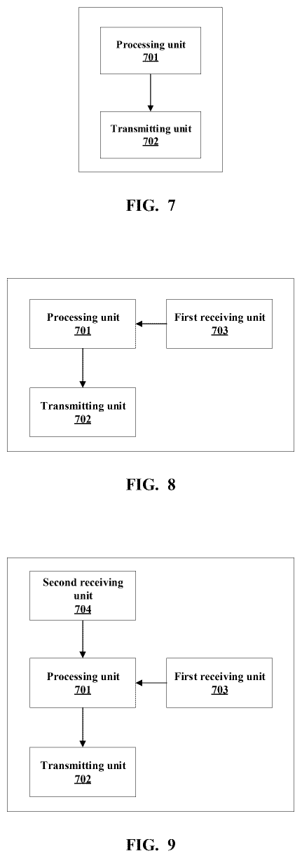

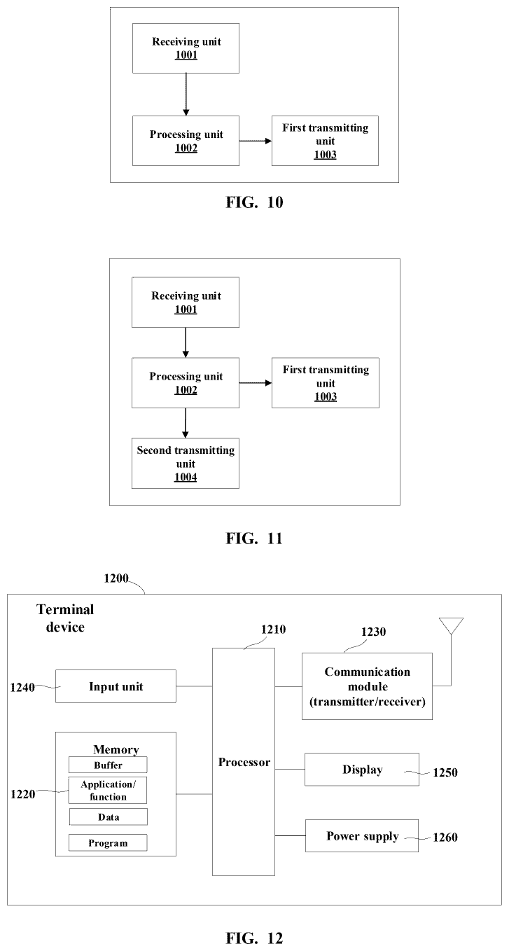

The first aspect of the present disclosure provides a communication system. As shown in FIG. 1, the communication system comprises: a terminal device 101, and a network device 102.

The terminal device 101 is configured to add, according to compensation frequencies corresponding to respective ROs in an RO group, the compensation frequencies to frequency-domain resources used for transmitting PRACH signals; and to transmit, using the RO group, the PRACH signals that have been frequency-compensated, that is, to transmit the PRACH signal using the RO group with frequency-domain compensation.

The RO group corresponds to a number of PRACH repetition transmissions. For example, if the RO group includes N RO time-frequency resources, the number of PRACH repetition transmissions is N.

The transmission of a PRACH signal may also be referred to as a transmission of a random access preamble.

In the present disclosure, the addition of compensation frequencies to frequency-domain resources refers to an addition of compensation frequencies to the frequencies of the frequency-domain resources, and by way of the frequency compensation, the frequency drift of the received PRACH caused by the Doppler frequency shift phenomenon is corrected.

In some embodiments, the compensation frequencies corresponding to the respective ROs in the RO group may be different. In specific implementation, the compensation frequency may be determined according to one or more of the constraints such as satellite capabilities, dynamic scenes, the used time-frequency resource parameter set, motion parameters (altitude, speed, etc.), and the like, and may also be configured by the network device 102. The present disclosure imposes no limitation on the absolute value of the compensation frequencies corresponding to the respective ROs in the RO group.

In some embodiments, the compensation frequencies corresponding to the respective ROs in the RO group are multiples of a basic compensation frequency. In specific implementation, the basic compensation frequency may be determined according to one or more of the constraints such as satellite capabilities, dynamic scenes, the used time-frequency resource parameter set, motion parameters (altitude, speed, etc.), and the like. The basic compensation frequency may also be configured by the network device 102. The present disclosure imposes no limitation on the way of determination and the numerical value of the basic compensation frequency.

In specific implementation, the multiple of the basic compensation frequencies corresponding to the respective ROs in the RO group are different. For example, the relationship of the multiples corresponding to the respective ROs in the RO group is: (N−1)*fo, (N−2)*fo, . . . , 1*fo, 0*fo; 0*fo, 1*fo, . . . , (N−2)*fo, (N−1)*fo; or (N/2)*fo, (N/2−1)*fo, . . . , 1*fo, 0*fo, −1*fo, . . . , −(N/2−1)*fo, where fo is the basic compensation frequency, and N is the number of ROs in the RO group. In the present disclosure, by adjusting a difference (which may also be referred to as a step size) between the multiples of the basic compensation frequency for adjacent ROs, real-time and high-precision frequency compensation can be carried in the random access information when the terminal device transmits the random access information, so that the network device (e.g., a base station) can receive the access information using a matching frequency.

In some embodiments, a sequence of values of the compensation frequencies for the RO group is a linear sequence or a non-linear sequence, wherein the sequence of the values of the compensation frequencies for the RO group is a sequence composed of the values of the compensation frequencies corresponding to the respective ROs in the RO group.

In some embodiments, the compensation frequencies corresponding to the respective ROs in the RO group are determined according to a basic compensation frequency and a compensation frequency calculation rule associated with the RO group, wherein the compensation frequency calculation rule is a rule that comprises the basic compensation frequency. The compensation frequency calculation rule specifies the way to determine the multiples of the basic compensation frequency corresponding to each RO. For example, the multiples of the basic compensation frequency for adjacent ROs are in an arithmetically increasing relationship, an arithmetically decreasing relationship, a non-arithmetically increasing relationship, or a non-arithmetically decreasing relationship, etc.

In some specific embodiments, the compensation frequency calculation rule includes:
Rule 1: (N−1)*fo, (N−2)*fo, . . . , 1*fo, 0*fo;
Rule 2:0*fo, 1*fo, . . . , (N−2)*fo, (N−1)*fo;
Rule 3: (N/2)*fo, (N/2−1)*fo, . . . , 1*fo, 0*fo, −1*fo, . . . , −(N/2−1)*fo.

The fo is the basic compensation frequency, and N is the number of ROs in the RO group. The above compensation frequency calculation rules are merely exemplary, and in specific implementation, other compensation frequency calculation rules may also be provided.

The network device 102 is configured to receive a plurality of PRACH signals transmitted by the terminal device; to determine, according to the plurality of PRACH signals, an optimal dynamic compensation frequency; and to transmit a random access response message indicating the optimal dynamic compensation frequency. The network device 102 may be located on a satellite or on the ground.

In specific implementation, the network device 102 may first receive the PRACH signals in sequence using a conventional PRACH acquisition algorithm (e.g., a matched filter or sliding correlation), and then determine the optimal dynamic compensation frequency according to the reception performance of each PRACH signal. The PRACH signal reception performance is, for example, the strongest output signal power of the matched filter or the highest correlation peak amplitude. That is, the PRACH signal corresponding to the strongest output signal power of the matched filter or the highest correlation peak amplitude is determined as the optimal signal, and the optimal dynamic compensation frequency is determined based on this optimal signal.

It should be noted that the compensation frequency in the present disclosure may also be referred to as an offset frequency. The two have the same meaning. The network device 102 is, for example, a base station, a payload device, etc.

By leveraging the repetition transmissions of random access information defined in the 3GPP standard specifications and using an RO group to transmit to the base station a PRACH signal that includes fine frequency compensation, these embodiments can improve the performance of the base station in receiving the random access information and improve the uplink coverage capability and capacity/throughput rate of the NTN.

In some embodiments, for a given number N of PRACH repetition transmissions (the RO group includes N ROs), if a time-domain offset parameter To is configured (for example, taking RO as the counting unit), the starting ROs of two repetition transmissions adjacent in the time-domain have the same frequency-domain starting point (starting RB or frequency-domain resource index), and are separated by To in the time-domain.

In some embodiments, when a plurality of types of PRACH repetition transmissions are configured, the RO group configurations used for each type of PRACH repetition transmission are different. For example, if two or more types of PRACH repetition transmissions with different numbers are configured, without loss of generality, taking repetition numbers N1 and N2 as an example, an RO group including N1 RO time-frequency resources is used for repetition transmissions with number N1, and an RO group including N2 RO time-frequency resources is used for repetition transmissions with number N2.

In some embodiments, when a plurality of types of PRACH repetition transmissions are configured, the compensation frequencies corresponding to the respective ROs in the respective RO groups are determined according to basic compensation frequencies and compensation frequency calculation rules associated with the respective RO groups.

Herein, the basic compensation frequencies associated with the respective RO groups are different. Taking the numbers of repetitions N1 and N2 as an example, the RO group used for repetition transmissions with number N1 may be associated with a first compensation frequency fo₁, and the RO group used for repetition transmissions with number N2 may be associated with a second compensation frequency fo₂.

The compensation frequency calculation rules associated with the respective RO groups are the same or different. The compensation frequency calculation rules are rules that include the basic compensation frequencies.

In some embodiments, for various types of PRACH repetition transmissions with different numbers, one of the compensation frequency calculation rules is used independently for each to configure the compensation frequencies for the time-frequency resources in the RO groups for the various types of PRACH repetition transmissions with different numbers. For example, the above-mentioned Rule 1, Rule 2, and Rule 3 are used respectively to configure the compensation frequencies for the time-frequency resources in the RO groups for the various types of PRACH repetition transmissions with different numbers.

In some embodiments, for various types of PRACH repetition transmissions with different numbers, one of the compensation frequency calculation rules is used jointly to configure the compensation frequencies for the time-frequency resources in the RO groups for the various types of PRACH repetition transmissions with different numbers. For example, one of the above-mentioned Rule 1, Rule 2, and Rule 3 is used to configure the compensation frequencies for the time-frequency resources in the RO groups for the various types of PRACH repetition transmissions with different numbers.

For different numbers of PRACH repetition transmissions, the terminal device adds, to frequency-domain resource used for transmitting PRACH signals, compensation frequencies corresponding to the respective ROs in the RO groups associated with the respective number of PRACH repetition transmissions, and transmits the PRACH signals using the corresponding RO resources that have been frequency-compensated. For the way in which the network device determines the optimal dynamic compensation frequency, reference may be made to the foregoing embodiments, and details are not described herein again.

In some embodiments, if PRACH repetition transmissions with a number N are configured, the RO group for the PRACH repetition transmissions includes a plurality of first RO groups. The terminal device adds, according to compensation frequencies corresponding to respective ROs in respective first RO groups, the compensation frequencies to frequency-domain resources used for transmitting PRACH signals, and transmits the PRACH signals that have been frequency-compensated using the respective first RO group, that is, transmitting the PRACH signals using the first RO group resources that have been frequency-compensated.

In specific implementation, the RO group used for repetition transmissions and the preamble corresponding to it are divided into two or more first RO groups in a certain manner (for example, according to the parity, numerical value, etc. of the preamble index), and each first RO group corresponds to a different compensation frequency (e.g., divided into two groups corresponding to fo1 and fo2, respectively).

The compensation frequencies corresponding to the respective ROs in the respective first RO groups are determined according to basic compensation frequencies and compensation frequency calculation rules associated with the respective first RO groups, wherein the basic compensation frequencies associated with the respective first RO groups are different, the compensation frequency calculation rules associated with the respective first RO groups are the same or different, and the compensation frequency calculation rules are rules that comprise the basic compensation frequencies.

In some embodiments, for an RO group configured with a time-domain period, the time-domain period comprises a plurality of SSB-RO association pattern periods, each of the plurality of SSB-RO association pattern periods comprises one or more RO groups. For example, the time-domain period X comprises K SSB-RO association pattern periods, where X and K are positive integers that can be preset, or configured by the network side, or specified by the protocol. The present disclosure imposes no limitation on the specific values of X and K. For example, a time-domain period of 480 ms includes three SSB-RO association pattern periods, that is, every 160 ms is one association pattern period. As another example, a time-domain period of 80 ms with each SSB-RO association pattern period being 20 ms includes four association pattern periods in total.

In an SSB-to-RO mapping association pattern period, there is at least one round of SSB-to-RO mapping, and each actually transmitted SSB has at least one RO corresponding to it. An SSB-to-RO mapping association pattern period is an integer multiple of the PRACH configuration period. As shown in FIG. 15, the NR standard specification further defines, through the association pattern period, the time-domain repetition period of the SSB-to-RO mapping association pattern period. For example, when the PRACH configuration period is 10 ms, the SSB-to-RO mapping association pattern period may be 1, 2, 4, 8, and 16 times the PRACH configuration period. For another example, when the PRACH configuration period is increased to 20 ms, the SSB-to-RO mapping association pattern period changes to 1, 2, 4, and 8 times the PRACH configuration period.

In some embodiments, the compensation frequencies corresponding to respective ROs in the one or more RO groups comprised in the same SSB-RO association pattern period are determined according to basic compensation frequencies and compensation frequency calculation rules associated with the respective RO groups. For the explanations of the basic compensation frequency and the compensation frequency calculation rule, reference can be made to the aforementioned embodiments, and details are not described herein again.

Herein, the basic compensation frequencies associated with the RO groups in different association pattern periods are different, the compensation frequency calculation rules associated with the one or more RO groups in a same association pattern period are the same or different, and the compensation frequency calculation rules are rules that comprise the basic compensation frequencies.

For example, if PRACH repetition transmissions with a time-domain period X are configured, the K SSB-RO association pattern periods within the time-domain period X may be associated with different basic compensation frequencies in a certain manner. For example, when K=3, the first association pattern period, the second association pattern period, and the third association pattern period are associated with a first basic compensation frequency fo₁, a second basic compensation frequency fo2, and a third basic compensation frequency fo₃, respectively. That is, the repetition transmission RO group within the first association pattern period is associated with the first basic compensation frequency fo₁, the repetition transmission RO group within the second association pattern period is associated with the second basic compensation frequency fo₂, and the repetition transmission RO group within the third association pattern period is associated with the third basic compensation frequency fo₃. For the repetition transmission RO group and RO resources within a certain association pattern period, the UE respectively adds certain frequency compensations in the frequency-domain and transmits PRACH signals using the RO groups with the frequency compensation (i.e., to transmit the PRACH signals that have been frequency-compensated using the RO group). The network device determines the optimal dynamic compensation frequency for the terminal device for different association pattern periods.

More specifically, if PRACH repetition transmissions with a time-domain period X are configured, for the basic compensation frequencies (e.g., fo₁, fo₂, and fo₃) associated with the repetition transmission RO groups in each association pattern period, one of the methods in Rule 1, Rule 2, and Rule 3 may be used independently for each to configure the corresponding compensation frequencies for the time-frequency resources (i.e., ROs) in their respective RO groups. Rule 1, Rule 2, and Rule 3 are merely exemplary. In specific implementation, other manners may also be selected, and the present disclosure imposes no limitation on this.

More specifically, if PRACH repetition transmissions with a time-domain period X are configured, for the basic compensation frequencies (e.g., fo₁, fo₂, and fo₃) associated with the repetition transmission RO groups in each association pattern period, the methods in Rule 1, Rule 2 and Rule 3 may be used jointly to configure the corresponding compensation frequencies for the time-frequency resources (i.e., ROs) in their respective RO groups.

In some embodiments, in the time-domain period X, one RO group (set) is determined or configured for a configured number of PRACH transmissions, and the determined or configured RO group or set is repeated in each time-domain period X. The time-domain period X comprises K SSB-RO association pattern periods, and the RO group corresponds to a different basic compensation frequency when applied to each of the association pattern periods.

In some embodiments, if PRACH repetition transmissions with a time-domain period X and a number N are configured, where X and N are positive integers that can be pre-configured, when each SSB has two or more corresponding RO groups within the time-domain period X (i.e., the same SSB is associated with a plurality of second RO groups), then compensation frequencies are added, according to the compensation frequencies corresponding to the respective ROs in each second RO group, to the frequency-domain resources used for transmitting PRACH signals. For example, if the time-domain period is 80 ms, then there are a plurality of second RO groups within the 80 ms.

In detail, the compensation frequencies corresponding to the respective ROs in the respective second RO groups are determined according to basic compensation frequencies and compensation frequency calculation rules associated with the respective second RO groups, wherein the basic compensation frequencies associated with the respective second RO groups are different, the compensation frequency calculation rules associated with the respective second RO groups are the same or different, and the compensation frequency calculation rules are rules that comprise the basic compensation frequencies.

In specific implementation, different basic compensation frequencies may be associated with different RO groups (i.e. second RO groups) in a certain manner. For example, they may be respectively associated with different basic compensation frequencies according to the sequence numbers of the RO groups (different RO groups corresponding to the same SSB are ordered following a sequence of first time-domain and then frequency-domain). For example, RO group #1 is associated with a basic compensation frequency fo₁, RO group #2 is associated with a basic compensation frequency fo₂, and so on. For the repetition transmission RO group and RO resources selected for each SSB in the time-domain period X, the UE may use one of the aforementioned methods in the above-mentioned Rule 1, Rule 2 and Rule 3 to determine the compensation frequencies corresponding to the respective ROs in the RO group, respectively adds a certain frequency offset in the frequency-domain, and transmits a PRACH signal using the RO group with the frequency offset. The network device determines the optimal dynamic compensation frequencies for the terminal device for different RO groups respectively.

In some embodiments, the terminal device 101 further receives, from the network device 102, indication information indicating RO group information for PRACH repetition transmissions and/or RO group information within a time-domain period, and frequency compensation information for an RO group.

In detail, the RO group information for repetition transmissions comprises the number of repetition transmissions, and the RO group information for each number of repetition transmissions.

The RO group information within a time-domain period includes the number of SSB-RO association pattern periods within the time-domain period, and the RO group information associated with each SSB.

The frequency compensation information for an RO group includes a basic compensation frequency and a compensation frequency calculation method or a corresponding indication code. The compensation frequency calculation method includes, for example, a step size value of the basic compensation frequency between adjacent ROs in various scenarios, wherein the scenarios include, for example, the terminal device and the satellite moving towards each other, the terminal device and the satellite moving away from each other, or the satellite passing directly over the terminal device, etc. The terminal device may select a corresponding basic compensation frequency and step size value based on the selected scenario.

In implementation, the indication information from the network device 102 may be included in one or more types of indication information such as master system information MIB, secondary system information SIB, RRC configuration information, DCI scheduling information, etc., and pre-indicates, in a certain manner, the compensation frequency configuration related to the PRACH resources (related to PRACH repetition transmissions, or to the ROs and RO groups) and the preamble in the terminal device, as well as the relevant correspondence relationship. For example, the indication is made by the base station and the terminal device according to the pre-determined configuration parameters, field codes, etc. (such as the newly added fields or multiplexed existing fields in system message 1 (SIB1) and/or SIB19 and/or SIB23).

The network device 102 captures a plurality of PRACH signals that have been frequency-compensated, and obtains an optimal dynamic compensation frequency fp according to the plurality of PRACH signals that are acquired. The network device 102 indicates the optimal dynamic compensation frequency fp to the terminal device in a certain manner in the response information such as Message 2 (Msg2) and/or Message 4 (Msg4) in the access procedure. For example, the indication is made through the network device and the terminal device according to the pre-determined configuration parameters, field codes, etc.

In some embodiments, the terminal device 101 is further configured to receive a random access response message from the network device. If the random access response message is not received within a preset time period, the terminal device re-determines compensation frequencies corresponding to the respective ROs in the RO group, re-executes addition of the compensation frequencies to frequency-domain resources used for transmitting PRACH signals, and re-transmits the PRACH signals that have been frequency-compensated. In specific implementation, for each RO group, when re-determining the compensation frequencies corresponding to the respective ROs in the RO group, the sequence of the values of the compensation frequencies for the RO group is different as compared to that in the previous determination of the compensation frequencies corresponding to the respective ROs in the RO group. For example, a different basic compensation frequency is used, and/or a different compensation frequency calculation rule is used, and so on.

This embodiments enable the network device to determine an optimal dynamic compensation frequency, so that the network device (base station) can receive the access information using a matching frequency, thereby achieving better reception performance.

### Embodiments of a Second Aspect

In some embodiments, a random access method applied to a terminal device is also provided. Specifically, as shown in FIG. 2, the random access method applied to a terminal device side comprises:
201, adding, according to compensation frequencies corresponding to the respective ROs in an RO group, the compensation frequencies to frequency-domain resources used for transmitting PRACH signals; and
202, transmitting, using the RO group, the PRACH signals that have been frequency-compensated.

One RO group corresponds to one number of PRACH repetition transmissions. The compensation frequencies corresponding to the respective ROs in the RO group are multiples of a basic compensation frequency, and the compensation frequencies for the respective ROs are different (i.e., the multiples of the basic compensation frequency are not fixed), and/or, a sequence of values of the compensation frequencies for the RO group is a linear sequence or a non-linear sequence, wherein the sequence of the values of the compensation frequencies for the RO group is a sequence composed of the values of the compensation frequencies corresponding to the respective ROs in the RO group. In specific implementation, the basic compensation frequency may be configured by a network device side, and the present disclosure imposes no limitation on its specific value.

After receiving the PRACH signal, the network device determines an optimal dynamic compensation frequency based on the received PRACH signals, and transmits a random access response message indicating this optimal dynamic compensation frequency.

In the present disclosure, by combining a random access occasion group (RO group) with PRACH transmission frequency compensation, a terminal device is enabled to carry real-time and high-precision frequency compensation in random access information when transmitting the random access information, such that a network device (base station) can receive the access information using a matching frequency, thereby achieving better reception performance.

In some embodiments, the compensation frequencies corresponding to the respective ROs in the RO group are determined according to the basic compensation frequency and a compensation frequency calculation rule associated with the RO group, wherein the compensation frequency calculation rule is a rule that comprises the basic compensation frequency.

For the process of determining the compensation frequencies corresponding to the respective ROs in the RO group based on the basic compensation frequency and the compensation frequency calculation rule, reference can be made to the aforementioned embodiments, and details are not described herein again.

In some embodiments, when a plurality of types of PRACH repetition transmissions are configured, the various RO groups used for PRACH repetition transmissions are different. The compensation frequencies corresponding to the respective ROs in the respective RO groups are determined according to basic compensation frequencies and compensation frequency calculation rules associated with the respective RO groups.

The basic compensation frequencies associated with the respective RO groups are different, the compensation frequency calculation rules associated with the respective RO groups are the same or different, and the compensation frequency calculation rules are rules that comprise the basic compensation frequencies.

In some embodiments, when one or more types of PRACH repetition transmissions are configured, the RO group for at least one type of PRACH repetition transmissions comprises a plurality of first RO groups. Compensation frequencies are added to frequency-domain resources used for transmitting PRACH signals according to the compensation frequencies corresponding to the respective ROs in the respective first RO groups, and the PRACH signals that have been frequency-compensated are transmitted using the corresponding ROs.

In specific implementation, the compensation frequencies corresponding to the respective ROs in the respective first RO groups are determined according to basic compensation frequencies and compensation frequency calculation rules associated with the respective first RO groups.

The basic compensation frequencies associated with the respective first RO groups are different, the compensation frequency calculation rules associated with the respective first RO groups are the same or different, and the compensation frequency calculation rules are rules that comprise the basic compensation frequencies.

In some embodiments, for an RO group configured with a time-domain period, the time-domain period comprises a plurality of SSB-RO association pattern periods, each of the plurality of SSB-RO association pattern periods comprises one or more RO groups.

Specifically, the compensation frequencies corresponding to the respective ROs in the one or more RO groups comprised in the same SSB-RO association pattern period are determined according to basic compensation frequencies and compensation frequency calculation rules associated with the respective RO groups.

The basic compensation frequencies associated with the RO groups in different association pattern periods are different, the compensation frequency calculation rules associated with one or more RO groups in a same association pattern period are the same or different, and the compensation frequency calculation rules are rules that comprise the basic compensation frequencies.

In some embodiments, for an RO group configured with a time-domain period, the time-domain period comprises a plurality of SSB-RO association pattern periods, and the same SSB is associated with a plurality of second RO groups.

In implementation of the random access method applied to a terminal device side, for each SSB-RO association pattern period, compensation frequencies are added to frequency-domain resources used for transmitting PRACH signals according to the compensation frequencies corresponding to the respective ROs in the respective second RO groups associated with the SSB, and the PRACH signals that have been frequency-compensated are transmitted using the second RO groups.

In detail, the compensation frequencies corresponding to the respective ROs in the respective second RO groups are determined according to basic compensation frequencies and compensation frequency calculation rules associated with the respective second RO groups.

The basic compensation frequencies associated with the respective second RO groups are different, the compensation frequency calculation rules associated with the respective second RO groups are the same or different, and the compensation frequency calculation rules are rules that comprise the basic compensation frequencies.

In some embodiments, as shown in FIG. 3, the random access method applied to a terminal device side further comprises:
301, receiving, from the network device, indication information indicating RO group information for PRACH repetition transmissions and/or RO group information within a time-domain period, and frequency compensation information for an RO group.

In some embodiments, as shown in FIG. 4, the random access method applied to a terminal device side comprises:
401, adding, according to compensation frequencies corresponding to the respective ROs in an RO group, the compensation frequencies to frequency-domain resources used for transmitting PRACH signals ;
402, transmitting, using the RO group, the PRACH signals that have been frequency-compensated.
403, receiving a random access response message from the network device;
404, executing step 405, if the random access response message is not received within a preset time period; and executing subsequent steps of the access procedure, if the random access response message is received within the preset time period; and
405, re-determining compensation frequencies corresponding to the respective ROs in the RO group, and returning to step 401 to repeat the execution.

### Embodiments of a Third Aspect

In some embodiments, a random access method applied to a network device side is also provided. As shown in FIG. 5, the random access method applied to a network device side comprises:
501, receiving a plurality of PRACH signals transmitted by a terminal device, wherein frequency-domain resources used for transmitting the PRACH signals are added with compensation frequencies;
502, determining, according to the plurality of PRACH signals, an optimal dynamic compensation frequency; and
503, transmitting a response message indicating the optimal dynamic compensation frequency.

When a number of PRACH repetition transmissions are configured, the repetition transmission RO group comprises N RO time-frequency resources, and the network device determines the optimal dynamic compensation frequency for the terminal for that number according to the above steps 501 to 503.

When multiple numbers of PRACH repetition transmissions are configured, the network device determines the optimal dynamic compensation frequency for each number of the PRACH repetition transmissions according to steps 501 to 503. For example, if the numbers of repetitions are N1 and N2, and the repetition transmission RO group comprises N1 or N2 RO time-frequency resources, the network device determines the optimal dynamic compensation frequency for the terminal in the case of N1 and/or N2 according to the above steps 501 to 503.

For PRACH repetition transmissions configured with a time-domain period X, the time-domain period X comprises K SSB-RO association pattern periods, each of the plurality of SSB-RO association pattern periods comprises one or more RO groups, and the network device determines the optimal dynamic compensation frequency for the terminal for each association pattern period according to the above steps 501 to 503.

For a given number of PRACH repetition transmissions, the RO group for repetition transmissions and the preamble corresponding to it are divided into two or more groups in a certain manner (for example, according to the parity, numerical value etc. of the preamble index), and the network device determines the optimal dynamic compensation frequency for the terminal for different preamble groups according to the above steps 501 to 503

For PRACH repetition transmissions configured with a time-domain period X and a number N, the time-domain period X comprises K SSB-RO association pattern periods, and each SSB has two or more corresponding RO groups in the time-domain period X, then the network device determines the optimal dynamic compensation frequency for the terminal for different RO groups corresponding to the SSB according to the above step 501 to 503.

In some embodiments, as shown in FIG. 6, the random access method applied to a network device side further comprises:
601, transmitting, to the terminal device, indication information indicating RO group information for PRACH repetition transmissions and/or RO group information within a time-domain period, and frequency compensation information for an RO group.

### Embodiments of a Fourth Aspect

In some embodiments, a random access apparatus applied to a terminal device side is also provided. As shown in FIG. 7, the random access apparatus applied to a terminal device side comprises:
a processing unit 701 configured to add, according to compensation frequencies corresponding to the respective ROs in an RO group, the compensation frequencies to frequency-domain resources used for transmitting PRACH signals; and
a transmitting unit 702 configured to transmit, using the RO group, the PRACH signals that have been frequency-compensated.

In some embodiments, the compensation frequencies corresponding to the respective ROs in the RO group are multiples of a basic compensation frequency; and/or
a sequence of values of the compensation frequencies for the RO group is a linear sequence or a non-linear sequence, wherein the sequence of the values of the compensation frequencies for the RO group is composed of the values of the compensation frequencies corresponding to the respective ROs in the RO group.

In some embodiments, the compensation frequencies corresponding to the respective ROs in the RO group are determined according to the basic compensation frequency and a compensation frequency calculation rule associated with the RO group, wherein the compensation frequency calculation rule is a rule that comprises the basic compensation frequency.

In some embodiments, when a plurality of types of PRACH repetition transmissions are configured, the RO group configurations adopted for the respective type of PRACH repetition transmissions are different.

The compensation frequencies corresponding to the respective ROs in the respective RO groups are determined based on the basic compensation frequencies and the compensation frequency calculation rules associated with the respective RO group.

The basic compensation frequencies associated with the respective RO groups are different, the compensation frequency calculation rules associated with the respective RO groups are the same or different, and the compensation frequency calculation rules are rules that comprise the basic compensation frequencies.

In some embodiments, the RO group comprises a plurality of first RO groups. The processing unit is configured to add, according to compensation frequencies corresponding to the respective ROs in the respective first RO groups, the compensation frequencies to frequency-domain resources used for transmitting PRACH signals.

The compensation frequencies corresponding to the respective ROs in the respective first RO groups are determined based on the basic compensation frequencies and the compensation frequency calculation rules associated with the respective first RO group.

The basic compensation frequencies associated with the respective first RO groups are different, the compensation frequency calculation rules associated with the respective first RO groups are the same or different, and the compensation frequency calculation rules are rules that comprises the basic compensation frequency.

In some embodiments, for an RO group configured with a time-domain period, the time-domain period comprises a plurality of SSB-RO association pattern periods, each of the plurality of SSB-RO association pattern periods comprises one or more RO groups.

The compensation frequencies corresponding to the respective ROs in the one or more RO groups comprised in the same SSB-RO association pattern period are determined according to basic compensation frequencies and compensation frequency calculation rules associated with the respective RO groups.

The basic compensation frequencies associated with the RO groups in different association pattern periods are different, the compensation frequency calculation rules associated with the one or more RO groups in a same association pattern period are the same or different, and the compensation frequency calculation rules are rules that comprise the basic compensation frequencies.

In some embodiments, a same SSB is associated with a plurality of second RO groups.

The processing unit is configured to add, according to compensation frequencies corresponding to the respective ROs in the respective second RO groups, the compensation frequencies to frequency-domain resources used for transmitting PRACH signals.

The compensation frequencies corresponding to the respective ROs in the respective second RO groups are determined according to basic compensation frequencies and compensation frequency calculation rules associated with the respective second RO groups.

The basic compensation frequencies associated with the respective second RO groups are different, the compensation frequency calculation rules associated with the respective second RO groups are the same or different, and the compensation frequency calculation rules are rules that comprise the basic compensation frequencies.

In some embodiments, as shown in FIG. 8, the random access apparatus applied to a terminal device side further comprises:
a first receiving unit 703 configured to receive, from a network device, indication information indicating RO group information for PRACH repetition transmissions and/or RO group information within a time-domain period, and frequency compensation information for an RO group.

In some embodiments, as shown in FIG. 9, the random access apparatus applied to a terminal device side further comprises:
a second receiving unit 704 configured to receive a random access response message from the network device.

The processing unit 701 is also configured, if the random access response message is not received within a preset time period, to re-determine compensation frequencies corresponding to the respective ROs in the RO group, re-execute addition of the compensation frequencies to frequency-domain resources used for transmitting PRACH signals, and re-transmit the PRACH signals that have been frequency-compensated by means of the transmitting unit 702.

It is worth noting that the above only describes the components or modules related to the present disclosure, but the present disclosure is not limited thereto. The random access apparatus applied to a terminal device side according to the embodiments of the present disclosure may also include other components or modules. For the specific contents regarding these components or modules, reference can be made to the related technologies.

Furthermore, for simplicity, FIGS. 7 to 9 only illustrate the connection relationship or signal flow among the components or modules. However, a person skilled in the art shall be clear that various related technologies such as bus connection can be employed. The components or modules can be implemented by hardware facilities such as processors, memories, transmitters, receivers, etc. The present disclosure does not give limitations on this.

The aforementioned embodiments only provide exemplary descriptions of the embodiments of the present disclosure, but the present disclosure is not limited thereto. Appropriate variations may also be made based on the aforementioned embodiments. For example, the aforementioned embodiments may be used individually, or one or more of the aforementioned embodiments may be used in combination.

### Embodiments of a Fifth Aspect

In some embodiments, a random access apparatus applied to a network device side is also provided. As shown in FIG. 10, the random access device applied to a network device side comprises:
a receiving unit 1001 configured to receive a plurality of PRACH signals transmitted by a terminal device, wherein frequency-domain resources used for transmitting the PRACH signals are added with compensation frequencies;
a processing unit 1002 configured to determine, according to the plurality of PRACH signals, an optimal dynamic compensation frequency; and
a first transmitting unit 1003 configured to transmit a response message indicating the optimal dynamic compensation frequency.

In some embodiments, as shown in FIG. 11, the random access device applied to a network device side further comprises:
a second transmitting unit 1004 configured to transmit, to the terminal device, indication information indicating RO group information for PRACH repetition transmissions and/or RO group information within a time-domain period, and frequency compensation information for an RO group.

It is worth noting that the above only describes the components or modules related to the present disclosure, but the present disclosure is not limited thereto. The random access apparatus applied to a network device side according to the embodiments of the present disclosure may also include other components or modules. For the specific contents regarding these components or modules, reference can be made to the related technologies.

Furthermore, for simplicity, FIG. 10 and FIG. 11 only illustrate the connection relationship or signal flow among the components or modules. However, a person skilled in the art shall be clear that various related technologies such as bus connection can be employed. The components or modules can be implemented by hardware facilities such as processors, memories, transmitters, receivers, etc. The present disclosure does not give limitations on this.

The aforementioned embodiments only provide exemplary descriptions of the embodiments of the present disclosure, but the present disclosure is not limited thereto. Appropriate variations may also be made based on the aforementioned embodiments. For example, the aforementioned embodiments may be used individually, or one or more of the aforementioned embodiments may be used in combination.

In summary, the present disclosure addresses the problem of how to enable a terminal device to carry real-time and high-precision frequency compensation when transmitting random access information, so that a base station can receive the access information using a matching frequency to obtain better reception performance. The present disclosure is applicable to high-dynamic NTN scenarios. When the UE performs enhanced initial access using PRACH re-transmissions, it is proposed to flexibly pre-configure a set of real-time and high-precision frequency offsets (compensations) in the PRACH signals repeatedly transmitted on the RO group resource, so that the network device (e.g., a base station) can receive the access information using a matching frequency to achieve better reception performance, and indicate an optimal offset (compensation) frequency to the terminal device. Subsequently, the UE employs an appropriate frequency offset for transmitting information based on the indication, thereby achieving the goal of improving the reception performance.

The present disclosure combines the random access occasion group method with PRACH transmission frequency compensation and provides specific details accordingly. The compensation (offset) frequency involved in the present disclosure is described in consideration of the initial compensation (calculated based on the ephemeris and the terminal's own location as mentioned above).

The embodiments of the present disclosure also provide a terminal device. However, the present disclosure is not limited thereto, but may also be other devices.

FIG. 12 is a schematic diagram of a terminal device according to an embodiment of the present disclosure. As shown in FIG. 12, the terminal device 1200 may comprise a processor 1210, and a memory 1220; the memory 1220 stores data and a program and is coupled to the processor 1210. It is worth noting that this figure is exemplary; other types of structures may also be used to supplement or replace this structure to realize telecommunication or other functions.

For example, the processor 1210 may be configured to execute the program to implement the random access method applied to a terminal device side.

As shown in FIG. 12, the terminal device 1200 may further comprise: a communication module 1230, an input unit 1240, a display 1250, and a power supply 1260. The functions of these components are similar to those in the prior art and will not be elaborated here. It is worth noting that the terminal device 1200 does not necessarily have to comprise all the components shown in FIG. 12. The above-mentioned components are not necessary. Furthermore, the terminal device 1200 may also comprise components not shown in FIG. 12, and reference can be made to the prior art.

The embodiments of the present disclosure also provide a network device, which may be, for example, a base station, but the application is not limited thereto, and it may also be other network devices.

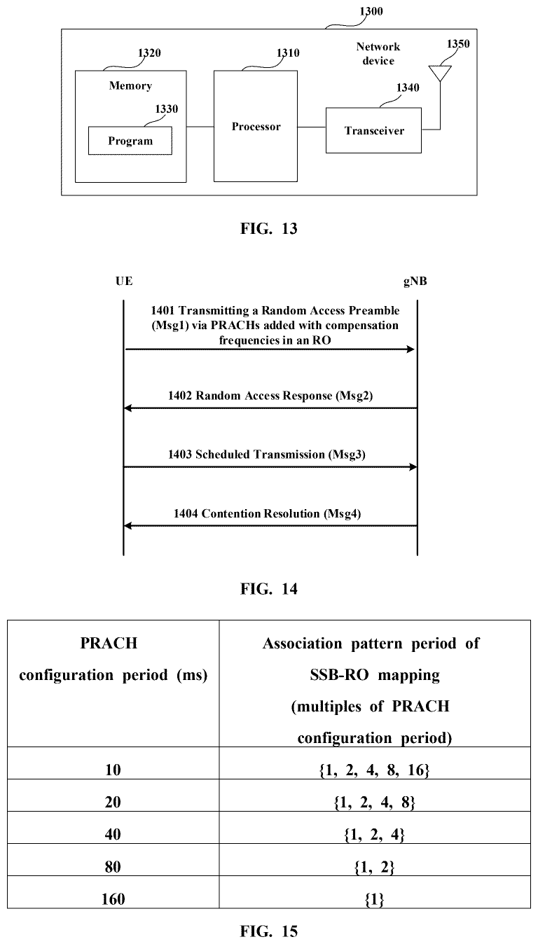

FIG. 13 shows a schematic diagram of the composition of a network device according to an embodiment of the present disclosure. As shown in FIG. 13, the network device 1300 may comprise: a processor 1310 (e.g., a central processing unit (CPU)) and a memory 1320; the memory 1320 is coupled to the processor 1310. The memory 1320 may store various data; furthermore, it may also store a program 1330 for information processing, and the program 1330 is executed under the control of the processor 1310.

For example, the processor 1310 may be configured to execute the program to implement the above-described random access method applied to a network device side.

In addition, as shown in FIG. 13, the network device 1300 may further comprise: a transceiver 1340, an antenna 1350, etc., wherein the functions of the components are similar to those in the prior art and will not be elaborated here. It is worth noting that the network device 1300 does not necessarily have to include all the components shown in FIG. 13; furthermore, the network device 1300 may also comprise components not shown in FIG. 13, and reference can be made to the prior art.

FIG. 14 shows a schematic diagram of a random access procedure according to an embodiment of the present disclosure, which gives an illustration using a 4-step CBRA as an example. As shown in FIG. 14, the method comprises:
1401: adding, by a UE, according to compensation frequencies corresponding to respective ROs in an RO group, the compensation frequencies to frequency-domain resources used for transmitting PRACH signals; that is, each time-frequency resource (RO) in the RO group is used for transmitting a PRACH signal after being frequency-compensated, and a Random Access Preamble (Msg1) is transmitted to the gNB;
the compensation frequencies corresponding to respective ROs in the RO group are multiples of a basic compensation frequency; and/or
a sequence of values of the compensation frequencies for the RO group is a linear sequence or a non-linear sequence, wherein the sequence of the values of the compensation frequencies for the RO group is composed of the values of the compensation frequencies corresponding to respective ROs in the RO group;
1402, receiving, by a network device, a plurality of PRACH signals transmitted by the terminal device; determining, by the network device, an optimal dynamic compensation frequency according to the plurality of PRACH signals; transmitting, by the network device, a random access response message indicating the optimal dynamic compensation frequency; and transmitting, by the network device to the terminal device, a Random Access Response (RAR) message (Msg2) indicating the optimal dynamic compensation frequency;
1403, transmitting, by the UE, a connection request message (Schedule Transmission) (Msg3) over the obtained uplink resource; and
1404, transmitting, by the network device, a Contention Resolution message (Msg4) to the UE that has successfully accessed.

In some embodiments, other operations may also be included. For the specific implementation thereof, reference can be made to the aforementioned embodiments, and details are not described herein again for the repeated contents.

In some embodiments, steps 1402 to 1404 are similar to the prior art and will not be elaborated here.

The embodiments of the present disclosure also provide a computer-readable program, wherein when the program is executed in a random access apparatus or a network device, the program causes a computer to execute, in the random access apparatus or the network device, the aforementioned random access method applied to a network device side, i.e., the method of the embodiments of the third aspect.

The embodiments of the present disclosure also provide a storage medium that stores a computer-readable program, wherein the computer-readable program causes a computer to execute, in a random access apparatus or a network device, the aforementioned random access method applied to a network device side, i.e., the method of the embodiments of the third aspect.

The embodiments of the present disclosure also provide a computer-readable program, wherein when the program is executed in a signal random access apparatus or a terminal device, the program causes a computer to execute, in the random access apparatus or the terminal device, the aforementioned random access method applied to a terminal device side, i.e., the method of the embodiments of the second aspect.

The embodiments of the present disclosure also provide a storage medium that stores a computer-readable program, wherein the computer-readable program causes a computer to execute, in a random access apparatus or a terminal device, the aforementioned random access method applied to a terminal device side, i.e., the method of the embodiments of the second aspect.

The above-described apparatuses and methods of the present disclosure can be implemented by hardware or by a combination of hardware and software. The present disclosure relates to such a computer-readable program that, when executed by a logic component, can enable the logic component to implement the apparatuses or constituent components described above, or can enable the logic component to implement the various methods or steps described above. The logic component includes, for example, a field programmable logic component, a microprocessor, a processor used in a computer, etc. The present disclosure also relates to a storage medium for storing the above program, such as a hard disk, a magnetic disk, an optical disk, a DVD, a flash memory, etc.

The methods/apparatuses described in conjunction with the embodiments of the present disclosure can be directly embodied as hardware, software modules executed by a processor, or a combination of both. For example, one or more of the functional block diagrams shown in the figures and/or one or more combinations of the functional block diagrams may correspond to various software modules of a computer program flow, and may also correspond to various hardware modules. These software modules may respectively correspond to the various steps shown in the figures. These hardware modules may be implemented, for example, by solidifying these software modules using Field Programmable Gate Arrays (FPGAs).

The software modules may be located in a RAM memory, a flash memory, an ROM memory, an EPROM memory, an EEPROM memory, a register, a hard disk, a removable disk, a CD-ROM, or any other form of storage medium known in the art. A storage medium may be coupled to a processor so that the processor can read information from, and write information into the storage medium; or the storage medium may be a constituent part of the processor. The processor and the storage medium may be located in an ASIC. This software module may be stored in the memory of a mobile terminal, and may also be stored in a storage card insertable into a mobile terminal. For example, if a device (e.g., a mobile terminal) uses a high-capacity MEGA-SIM card or a high-capacity flash memory device, the software module may be stored in that MEGA-SIM card or high-capacity flash memory device.

One or more of the functional blocks shown in the drawings and/or one or more combinations of the functional blocks may be implemented as a general-purpose processor, a digital signal processor (DSP), an application-specific integrated circuit (ASIC), a field-programmable gate array (FPGA), or other programmable logic device, discrete gate or transistor logic device, discrete hardware component, or any suitable combination thereof, for performing the functions described in the present disclosure. One or more of the functional blocks shown in the drawings and/or one or more combinations of the functional blocks may also be implemented as a combination of computing devices, such as a combination of a DSP and a microprocessor, a combination of multiple microprocessors, multiple microprocessors, one or more microprocessors in conjunction with DSP communication, or any other such configurations.

The above describes the present disclosure in conjunction with the specific embodiments, but a person skilled in the art shall understand that these descriptions are merely exemplary and do not limit the scope of protection of the present application. A person skilled in the art can make various variations and modifications to the present application based on the spirit and principle of the present application, and these variations and modifications are also within the scope of the present application.

1. A random access apparatus, applied to a terminal device, comprising:
a processor; and
a memory configured to store instructions executable by the processor,
wherein the processor is configured to:
add, according to compensation frequencies corresponding to respective ROs in an RO group, the compensation frequencies to frequency-domain resources used for transmitting PRACH signals; and
transmit, using the RO group, the PRACH signals that have been frequency-compensated.

2. The apparatus according to claim 1, wherein the compensation frequencies corresponding to the respective ROs in the RO group are multiples of a basic compensation frequency; and/or
a sequence of values of the compensation frequencies for the RO group is a linear sequence or a non-linear sequence, wherein the sequence of the values of the compensation frequencies for the RO group is a sequence composed of the values of the compensation frequencies corresponding to the respective ROs in the RO group.

3. The apparatus according to claim 1, wherein the compensation frequencies corresponding to the respective ROs in the RO group are determined according to a basic compensation frequency and a compensation frequency calculation rule associated with the RO group, wherein the compensation frequency calculation rule is a rule that comprises the basic compensation frequency.

4. The apparatus according to claim 1, wherein when a plurality of types of PRACH repetition transmissions are configured, RO group configurations used for respective types of PRACH repetition transmissions are different, and compensation frequencies corresponding to respective ROs in respective RO groups are determined according to basic compensation frequencies and compensation frequency calculation rules associated with the respective RO groups; and
wherein the basic compensation frequencies associated with the respective RO groups are different, the compensation frequency calculation rules associated with the respective RO groups are same or different, and the compensation frequency calculation rules are rules that comprise the basic compensation frequencies.

5. The apparatus according to claim 1, wherein the RO group comprises a plurality of first RO groups, and the processor is further configured to add, according to compensation frequencies corresponding to respective ROs in respective first RO groups, the compensation frequencies to frequency-domain resources used for transmitting PRACH signals.

6. The apparatus according to claim 5, wherein the compensation frequencies corresponding to the respective ROs in the respective first RO groups are determined according to basic compensation frequencies and compensation frequency calculation rules associated with the respective first RO groups; and
wherein the basic compensation frequencies associated with the respective first RO groups are different, the compensation frequency calculation rules associated with the respective first RO groups are same or different, and the compensation frequency calculation rules are rules that comprise the basic compensation frequencies.

7. The apparatus according to claim 1, wherein for an RO group configured with a time-domain period, the time-domain period comprises a plurality of SSB-RO association pattern periods, and each of the plurality of SSB-RO association pattern periods comprises one or more RO groups;
wherein the compensation frequencies corresponding to respective ROs in the one or more RO groups comprised in a same SSB-RO association pattern period are determined according to basic compensation frequencies and compensation frequency calculation rules associated with respective RO groups; and
wherein the basic compensation frequencies associated with the RO groups in different association pattern periods are different, the compensation frequency calculation rules associated with the one or more RO groups in a same association pattern period are same or different, and the compensation frequency calculation rules are rules that comprise the basic compensation frequencies.

8. The apparatus according to claim 1, wherein a same SSB is associated with a plurality of second RO groups; and
the processor is further configured to add, according to compensation frequencies corresponding to respective ROs in respective second RO groups, the compensation frequencies to frequency-domain resources used for transmitting PRACH signals.

9. The apparatus according to claim 8, wherein the compensation frequencies corresponding to the respective ROs in the respective second RO groups are determined according to basic compensation frequencies and compensation frequency calculation rules associated with the respective second RO groups; and
wherein the basic compensation frequencies associated with the respective second RO groups are different, the compensation frequency calculation rules associated with the respective second RO groups are same or different, and the compensation frequency calculation rules are rules that comprise the basic compensation frequencies.

10. The apparatus according to claim 1, wherein the processor is further configured to:
receive, from a network device, indication information used to indicate RO group information for PRACH repetition transmissions and/or RO group information within a time-domain period, and frequency compensation information for an RO group.

11. The apparatus according to claim 1, wherein the processor is further configured to:
receive a random access response message from a network device;
wherein if the random access response message is not received within a preset time period, re-determine the compensation frequencies corresponding to the respective ROs in the RO group, re-execute addition of the compensation frequencies to the frequency-domain resources used for transmitting the PRACH signals, and re-transmit the PRACH signals that have been frequency-compensated by means of a transmitter.

12. A random access apparatus, applied to a network device, comprising:
a processor; and
a memory configured to store instructions executable by the processor,
wherein the processor is configured to:
receive a plurality of PRACH signals transmitted by a terminal device, wherein frequency-domain resources used for transmitting the PRACH signals are added with compensation frequencies;
determine, according to the plurality of PRACH signals, an optimal dynamic compensation frequency; and
transmit a random access response message indicating the optimal dynamic compensation frequency.

13. The apparatus according to claim 12, wherein the processor is further configured to:
transmit, to the terminal device, indication information indicating RO group information for PRACH repetition transmissions and/or RO group information within a time-domain period, and frequency compensation information for an RO group.

14. A random access method, applied to a terminal device, comprising:
adding, according to compensation frequencies corresponding to respective ROs in an RO group, the compensation frequencies to frequency-domain resources used for transmitting PRACH signals; and
transmitting, using the RO group, the PRACH signals that have been frequency-compensated.

15. The method according to claim 14, wherein the compensation frequencies corresponding to the respective ROs in the RO group are multiples of a basic compensation frequency; and/or
a sequence of values of the compensation frequencies of the RO group is a linear sequence or a non-linear sequence, wherein the sequence of the values of the compensation frequencies for the RO group is a sequence composed of the values of the compensation frequencies corresponding to the respective ROs in the RO group.

16. The method according to claim 14, wherein the compensation frequencies corresponding to the respective ROs in the RO group are determined according to a basic compensation frequency and a compensation frequency calculation rule associated with the RO group, wherein the compensation frequency calculation rules are rules that comprise the basic compensation frequencies.

17. The method according to claim 14, wherein when a plurality of types of PRACH repetition transmissions are configured, various RO groups used for the PRACH repetition transmissions are different, and compensation frequencies corresponding to respective ROs in respective RO groups are determined according to basic compensation frequencies and compensation frequency calculation rules associated with the respective RO groups; and
wherein the basic compensation frequencies associated with the respective RO groups are different, the compensation frequency calculation rules associated with the respective RO groups are same or different, and the compensation frequency calculation rules are rules that comprise the basic compensation frequencies.

18. The method according to claim 14, wherein the RO group comprises a plurality of first RO groups, and compensation frequencies are added to frequency-domain resources used for transmitting PRACH signals according to the compensation frequencies corresponding to respective ROs in respective first RO groups.

19. The method according to claim 14, further comprising,
for an RO group configured with a time-domain period, the time-domain period comprises a plurality of SSB-RO association pattern periods, each of the plurality of SSB-RO association pattern periods comprises one or more RO groups;
wherein the compensation frequencies corresponding to respective ROs in the one or more RO groups comprised in a same SSB-RO association pattern period are determined according to basic compensation frequencies and compensation frequency calculation rules associated with respective RO groups; and
wherein the basic compensation frequencies associated with the RO groups in different association pattern periods are different, the compensation frequency calculation rules associated with the one or more RO groups in a same association pattern period are same or different, and the compensation frequency calculation rules are rules that comprise the basic compensation frequencies.

20. The method according to claim 14, wherein a same SSB is associated with a plurality of second RO groups; and
compensation frequencies are added to frequency-domain resources used for transmitting PRACH signals according to the compensation frequencies corresponding to respective ROs in respective second RO groups.
